(19) United States
(12) Patent Application Publication
(10) Pub. No.: US 2002/0178132 A1
(43) Pub. Date: Nov. 28, 2002

(54) Adaptive system for recognition of multi-channel amplitude varying signals

(76) Inventor: Ralph E. Rose, San Jose, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/823,735

(22) Filed: Mar. 30, 2001

(51) Int. Cl. G06F 15/18

(52) U.S. Cl. 706/20

(57) ABSTRACT

A signal recognition system is provided which is initially capable of being programmed to learn how to recognize a signal. Using as signal inputs amplitude varying signals representative of different frequency components of a single audio channel, a frequency discriminator is used to provide data on which to train a State Machine Block in a feedback relationship with an Adjustment Block. As the trainable system is trained, the value of parameters in the State Machine Block is adjusted to modify system behavior. After the system has been fully trained, the resultant database of states created as a result of training is exported to a system with lesser capability, namely a system adapted for mere recognition of the input signals.

### BACKGROUND OF THE INVENTION

This invention is related to identification of time-varying signals from a variety of time-varying signal types. The mechanism for recognition is to feed the multi-channel time varying signal to a state machine in which the recognition node responsible for recognition of this particular signal is to produce a pulse. The technique for recognition is to monitor all such recognition nodes for pulses, etc. The technique for training of this state machine's recognition node is also provided. To use this system for the recognition of speech, the single channel of audio is broken down into a number of channels; each channel representing the time varying amplitude of a different frequency component.

While the technology described in this application is new, it is built on the earlier technology of the present inventor described in issued U.S. Pat. No. 6,128,609 entitled “Training a Neural Network Using Differential Input,” and in patent applications Ser. No. 09/693,003 filed Oct. 20, 2000 entitled “Method and Apparatus for Training a State Machine” and Ser. No. 09/708,902 filed Nov. 7, 2000 entitled “Structure of a Trainable State Machine.”

### SUMMARY OF THE INVENTION

According to the invention, a system is provided which is capable of recognition or classification of a time-varying signal among a number of time-varying signal types. The technique for recognition is by use of a state machine block. The state machine block contains a number of recognition nodes. Each recognition node will be responsible for recognition of a different signal object. The recognition node will signal its recognition to the rest of the system by the producing a pulse. The state machine block will not be programmed but trained. The program in the system will be limited to: 1) a learning algorithm and 2) a technique for simulating the state machine block. Because training significantly increases the processing requirements, two systems are contemplated. These systems are: a larger system capable of learning, and a system only capable of utilizing the learned data for recognition.

The database information permitting the system to recognize objects or word will be contained in the parameters in the state machine block. It will be these parameter values that will be transferred from the large system to the smaller system. To utilize this system for the recognition of spoken language, it is necessary to break the single channel of audio into a number of channels—each channel representing the time varying amplitude of a different frequency component.

There are many applications of a system capable of adaptive recognizing multi-channel amplitude varying signals, only one of which is speech recognition. Applications for multiple-speaker word recognition and speaker-independent speech recognition are not discussed herein, although it is believed that a system according to the invention can be trained to recognize words from the speech of a number of speakers using the training techniques according to the invention.

The invention will be better understood by reference to the following detailed description in connection with the accompanying drawings.

### BRIEF DESCRIPTION OF THE DRAWINGS

FIG. 1 is a block diagram of a word detector using a state machine as a major component.

FIG. 2 is a block diagram of the word detector of FIG. 1 modified for training.

FIG. 3 is a flow graph of the modified DFT algorithm to generate an array of amplitude varying frequency component signal of single channel audio input.

FIGS. 4a and 4b are schematic diagrams of an illustrative Lead-Type Node and a Non-Lead-Type Node.

FIGS. 5a and 5b are Electrical Component Models of a Lead-Type Network and a Non-Lead-Type Network.

FIG. 6 is a flow graph for training the pulse output of a Recognition Node and the non-pulse output of a number of other Recognition Nodes, all at the same time using the matrix or the reiterative algorithm.

FIG. 7 is a flow graph that is supplement to FIG. 5 for training multiple Recognition Nodes.

### DESCRIPTION OF SPECIFIC EMBODIMENTS

It is assumed that the objective of the system being designed is to recognize spoken words. Part of the task the system must perform is to generate the multi-channel amplitude varying signals from the single channel audio input.

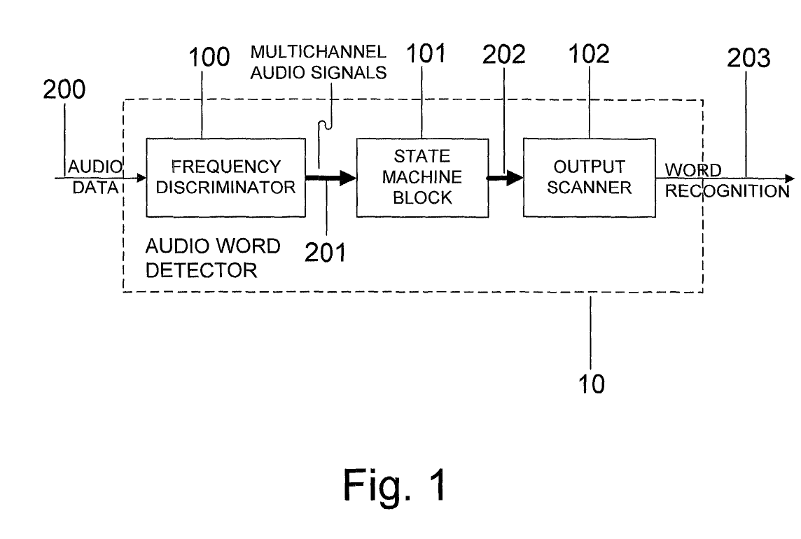

Referring to FIG. 1, in a specific embodiment of the invention, an audio word detector 107 is used for illustration. A frequency discriminator 100 receives audio data in the form of a sampling of a time-varying signal from which frequency and time components can be extracted for analysis. The positive recognition of an individual word, sound or phrase, etc. by a State Machine Block 101 is indicated by the output of an amplitude pulse or like signal by a Recognition Node (node shown) within the State Machine Block 101. A Recognition Node is provided for each word or object for which the State Machine Block 101 is trained to recognize. When the State Machine Block 101 receives input of an analog signal containing a word or object which the State Machine Block 101 has been trained to recognize, the appropriate Recognition Node responds with the production of an appropriate analog amplitude pulse. A positive pulse that is larger (at a higher amplitude) than an Upper Trip Level or recognition threshold indicates recognition. An Output Scanner 102 scans the output of all the Recognition Nodes for existence of any such pulses. If the Output Scanner 102 observes a positive pulse larger than the Upper Trip Level, it notifies an external system (not shown), of the recognition of a specific word, etc.

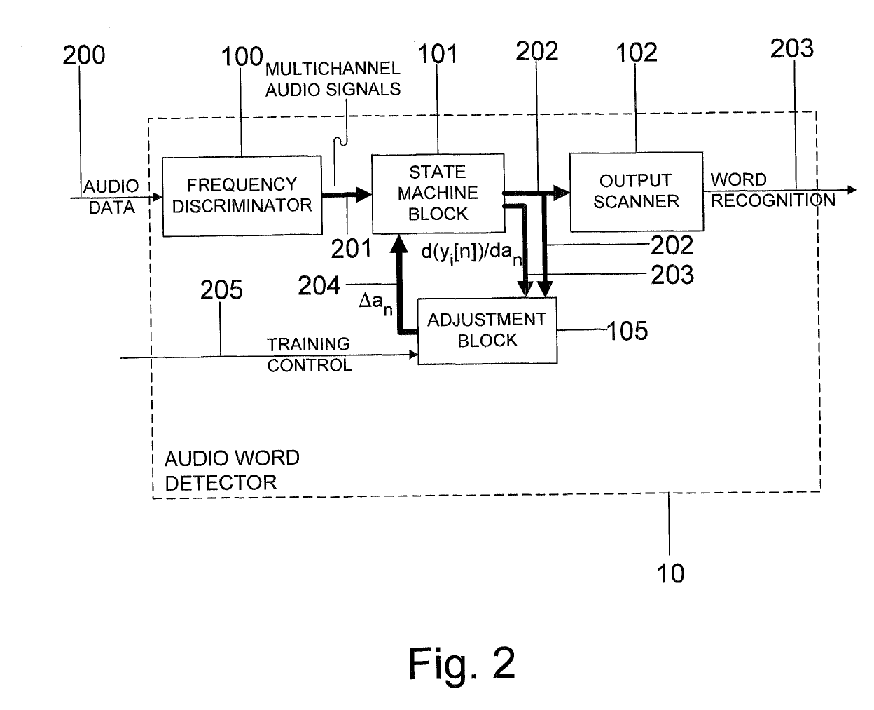

To train the State Machine Block 101 of FIG. 1, in order induce the recognition algorithm to avoid the ambiguous zone between the Upper Trip Level and the Lower Trip Level, it necessary to modify the system. This modification is shown in FIG. 2. If the Output Scanner 102 observes a positive pulse that is in the ambiguous zone above the Lower Trip Level but less than the Upper Trip Level, the Adjustment Block 105 responds by causing the State Machine Block 101 to be trained to either produce a pulse that is larger than the Upper Trip Level or less than the Lower Trip Level. To determine which of these two responses, the Adjustment Block 105 uses the inputs of the Training Control 200 to determine if the present signal input is good data or bad data for this Recognition Node. Good data is reinforced by training the pulse to be above the Upper Trip Level and bad data is reinforced by training the pulse to be below the Lower Trip Level. The training of the Recognition Node involves the use of derivative variables and a Behavioral Model. The Behavioral Model is used to determine when the appropriate Recognition Node should produce a pulse. The data point used for training for positive recognition will typically be the point of desired maximum pulse amplitude. The training level for positive recognition will be the Upper Training Level. The data point for non-recognition will typically be the point of maximum amplitude of the pulse. The training level for non-recognition will be the Lower Training Level. Since only one data point will be used for training, there is no need to refer to the error as an error variable. It can instead be referred to as an error value. At this data point, the value of the derivative variables on signal line 203 will be collected and used with the error value for training. The value of error value will be determined by subtracting the value of the actual output of the appropriate Recognition Node on signal line 202 from the desired output as determined by the Behavioral Model contained within the Adjustment Block 105. The error value and the derivative variables constitute the Training Data for this data point. Typically the Training Data from a number of data points is collected and stored before a Training Cycle is made. At the end of a Training Cycle an array of parameter change values is calculated and fed on signal line 204 to the State Machine Block 101 to change the value of the parameters within, thereby changing its behavior.

To increase the depth of the network of state equations within the State Machine Block 101 that can be trained, differential variables can be used. The use of differential variables for training involves the use of derivative variables for the differential variables or differential derivative variables. The uses of differential variables and differential derivative variables is summarized herein for completeness. In addition, a summary is provided of 1) the structure of the state equations or nodes within the State Machine Block, and 2) the training algorithms used.

Algorithm Used by Frequency Discriminator 100

The objective of the Frequency Discriminator 100 is to convert a single channel of audio data to a number of channels of audio data. Each channel will represent the amplitude of a different frequency component of the audio signal. To accomplish the task of converting a single audio channel to a number of channels of audio data, a modified FFT algorithm will be used.

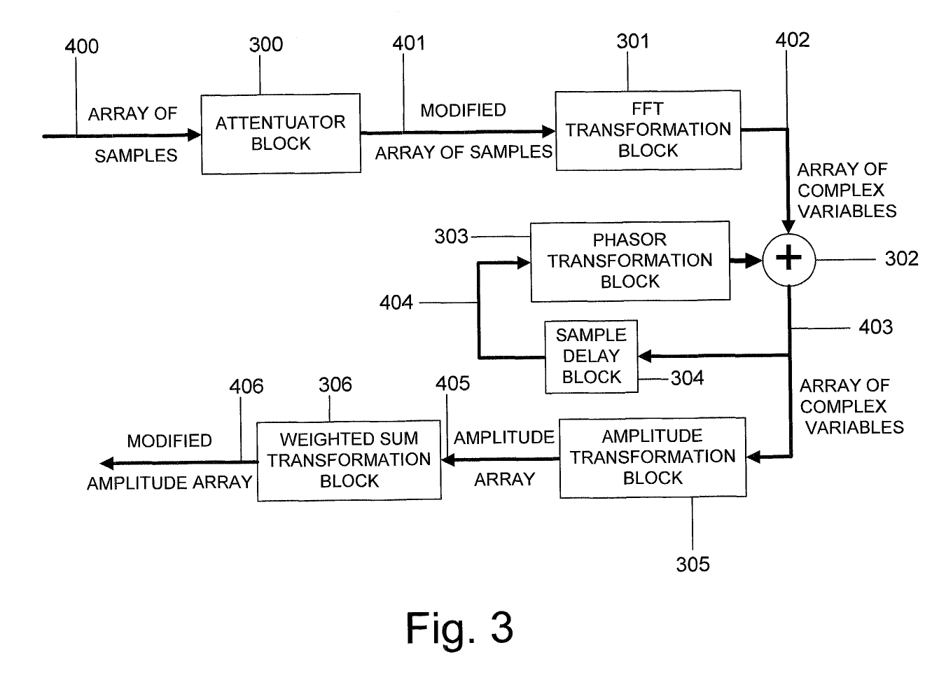

Referring to FIG. 3, an array of samples on signal line 400 is processed through an Attenuator Block 300. The amount of attenuation of each sample will depend on how long ago the sample was taken. The most recently taken sample will not be attenuated while earliest sample taken will be attenuated the most. In the value multiplied by each sample, e^{-αT}, the value of T is the variable. If h is the sampling interval, T=nh, where n is the number of sampling intervals occurring since the sample was taken. The value of α is determined by the complex phasor used in Phasor Transformation Block 303. The number of samples in the array of samples at 400 and 401 are 256 or 512, depending on the FFT Transformation performed in FFT Transformation Block 301. The output of the FFT Transformation Block 301 is an array of complex numbers. Each of the complex numbers on signal line 402 represents the sine and cosine component of a different frequency component of the audio input from which the array of samples on signal line 400 were collected. If the FFT uses 256 samples, the phasor of highest frequency of the FFT's output will represent a frequency of

$${f}_{h} = \frac{1}{2 h} .$$

The phasor of the lowest frequency will represent a frequency of

$${f}_{l} = \frac{{f}_{h}}{256} .$$

The other phasors in the array of complex number on signal line 403 and 404 will represent frequencies of:

$${f}_{i} = {if}_{j} \qquad ( 1 )$$

where i varies from one to 256. These phasor components are normally presented to the user as an array of complex numbers. The real and imaginary components of these phase components represent the relative amplitude of the sine and cosine components. The data points are always collected at the same time interval. As soon as enough sample values has been collected, they are processed through blocks 300 and 301. While these data points are being processed, the next array of samples is collected. Data points will be collected at a constant interval, and if the data point is not used in one array of samples it will be used on the next one, etc.

There is a problem of merging the FFT's current output with the previous FFT outputs. This is done by using Phasor Transformation Block 303, Summer 302, and Sample Delay Block 304. The complex number or phasor used by the Phasor Transformation Block 303 by which to multiply the previous FFT phasor components will vary with each frequency. The value of this complex number or phasor can be calculated using:

phasor(ω)=e^{-αT}[ sin(ωT)+\overline{i} cos(ωT)] (2)

where T is the time period since the last FFT. If the FFT performed by the FFT Transformation Block 301 is a 256 sample FFT, the value of Twill be 256 h. The value of α in Equation (1) is the same value of the α used in block 300 and will be constant for all frequencies. The value of ω will vary with the frequency and be calculated using 2πƒᵢ where ƒᵢ is determined using Equation (1). In Equation (2) the part of the expression on the right not multiplied by \overline{i} is the real part and the part multiplied by \overline{i} is the imaginary part. When phasor of Equation (2) by the array of complex variables on signal line 404, it is necessary to remember that (\overline{i})²=−1.

After the values of the previous FFT on signal line 404 have been converted they are added to the values of the present FFT on signal line 402 in Summer 302. At this point there is a need to convert the phasor components on signal line 403 to pure amplitude. This is done in the Amplitude Transformation Block 305. The equation used by the Amplitude Transformation Block 305 to generate the array of amplitude on signal line 405 is Equation (3). The amplitude of the phase component can be determined from:

amplitude(ω)=\sqrt{real²(ω)+imaginary²(ω)} (3)

In FIG. 3 the signal on signal line 405 represents an amplitude value for each frequency phasor output of the FFT Transformation Block 301. To reduce the number of inputs to be sent to the State Machine Block 101 in FIG. 1 or 2, a weighted sum is used. The output of Block 306 is determined by:

$$AmplitudeOut ( {ω}_{c} ) = {\sum }_{ω = 0}^{ω = Max} {ⅇ}^{- σΔω} AmplitudeIn ( ω ) \qquad ( 4 )$$

where:

Δω=|ω−ω_{c}| (5)

The vertical lines around the value on the left side of Equation (5) mean the absolute value of the value enclosed. By using Equation (4) a number of times to the input array on signal line 405, each time with a different value of ω_{c}, a reduced number of variables can be calculated for input to the State Machine Block 101 of FIG. 1 or 2. The value of σ in Equation (4) is chosen so that the bell shaped curve of the weighted sums overlap.

### Structure of a State Machine Block

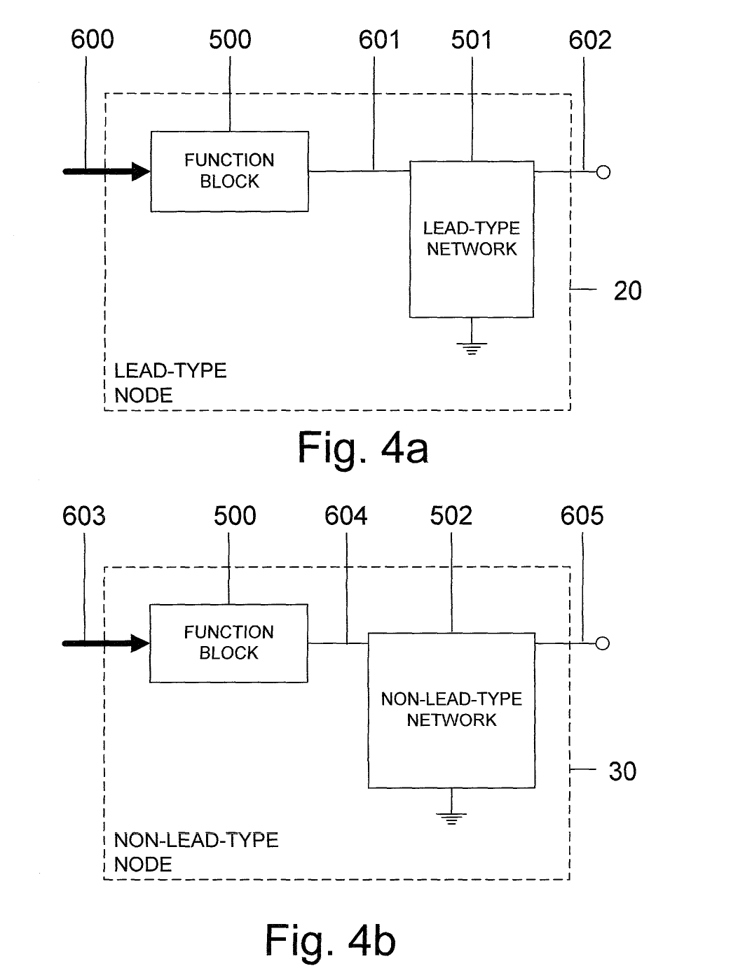

To explain the structure of the State Machine Block 101 it is helpful to refer to each equation in the state machine as a Nodes. For purpose of this discussion it is not necessary to understand the internal structure of a Node. It is only necessary to understand that there are two types of Nodes. The two types of Nodes are Lead-Type Nodes 20 and Non-Lead-Type Nodes 30 as shown in FIGS. 4a and 4b. The rate of change of the output of a Lead-Type Node is a function of one or more of the Node's inputs. For a Non-Lead-Type Node, the rate of change of the output is only a function of the level of the Node's inputs. The fact that the rate of change of the output of a Lead-Type Node is a function of the rate of change of the Node's inputs, means that in order to determine the rate of change of a Lead-Type Node's output, it is first necessary to know the rate of change of all the Lead-Type Node's inputs. This restricts the order in which the Nodes can be processed. In fact if care is not taken to avoid the problem, a loop of Lead-Type Nodes can inadvertently be built. When this occurs, an alternate procedure must be used.

To correctly determine the rate of change of the output of any Lead-Type Node when a loop is created, it necessary to use a matrix. Each equation in this matrix expresses the rate of change of one node's output as a function of the rate of change of its input node.

The setup and solution of this matrix is a very cumbersome process that would have to be performed on each processing cycle. According to the invention, in order to eliminate the possibility of building a loop of Lead-Type Nodes, the system inputs to the State Machine Block are inputted at one end (top) and the system outputs from the State Machine Block 101 are taken from the other end (bottom). The Nodes passing signals in the direction of top to bottom can be Lead-Type Nodes or Non-Lead-Type Nodes. Nodes passing signals in the direction of bottom to top are restricted to Non-Lead-Type Nodes.

The sequence in which the Nodes are processed within a processing cycle is also controlled. At the start of the processing cycle all Nodes passing a signal from the bottom to the top are processed, then all Nodes passing a signal from the top to the bottom are processed in layer order, that is, all Nodes in the top layer are processed followed by all Nodes in the second layer, etc. By processing the Nodes in this order, a change in the system inputs can cause changes to appear at the system outputs within one processing cycle.

### Structure of a Node

A Node is a structure that functions as a state equation within the State Machine Block 101. A Node 20, 30 in FIGS. 4a and 4b contains a Function Block 500 and a Complex Impedance Network 501 or 502. These two components are interconnected as shown by FIGS. 4a and 4b by only one signal flowing from the Function Block 500 to the Complex Impedance Network 501 or 502. In FIG. 4a, the node 20 is a Lead-Type Node and the Complex Impedance Network 501 is a Lead-Type Network. The characteristic that distinguishes a Lead-Type Node from a Non-Lead-Type Node is the type of Complex Impedance Network it uses. A Lead-Type Node will use a Lead-Type Network, while a Non-Lead-Type Node will use a Non-Lead-Type Network.

### Structure of Complex Impedance Network

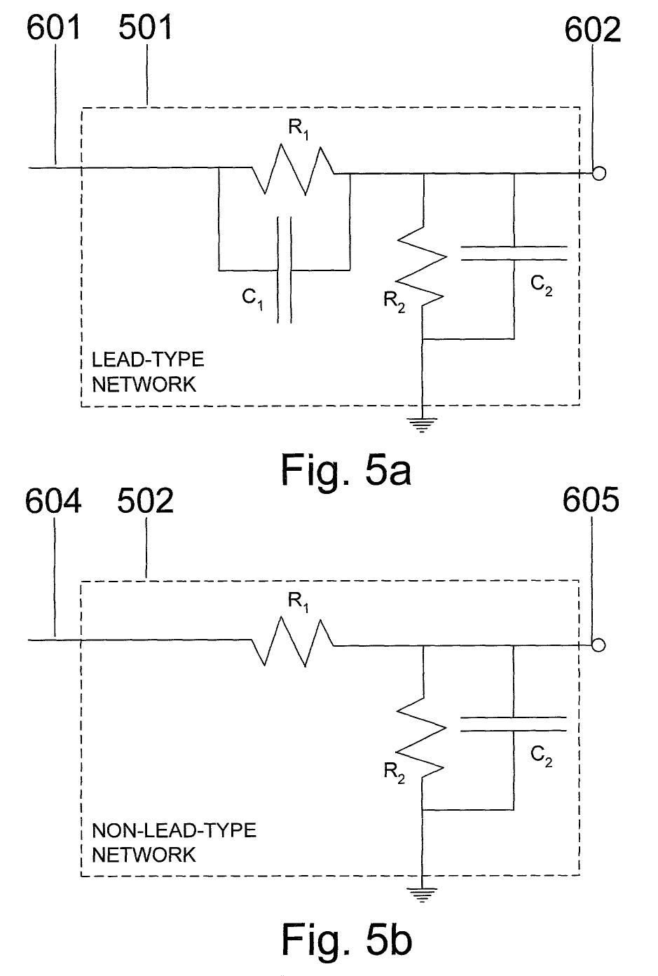

In FIGS. 5a and 5b are electrical model of a Lead-Type Network and a Non-Lead-Type Network respectively. The major difference in their design is that for a Lead-Type Network the rate of change of the output of can be a function of the rate of change of the input while for a Non-Lead-Type Network the rate of change of the output can only be a function of the level of the input. In FIG. 5a, the input is supplied as a voltage on signal line 601 while the output voltage is taken from signal point 602. In FIG. 5b, the input is supplied as a voltage on signal line 604 while the output voltage is taken from signal point 605. Analysis of these electrical models shows that they satisfy the requirement of inputs controlling the rate of change of the output.

### Processing Strategy

An integral part of the processing strategy is the choice of integration technique used. The integration technique that will be used is the rectangular integration technique. This technique can be summarized by the following equation:

$${e}_{o} [ n + 1 ] = {e}_{o} [ n ] + Δ t ( \frac{ⅆ {e}_{o} [ n ]}{ⅆ t} ) \qquad ( 6 )$$

The signals that must be passed through the system of nodes are normal variables and an array of derivative variables. At each signal point there will be a normal variable and an array of derivative variables. The structure that will be used to contain all these variables is a VarType. This structure will contain a float for the value of the normal variable and a float pointer that will point to an array of derivative variables.

Each node consists of two components: 1) the Function Block or multivariable power series; 2) Complex Impedance Network. The Complex Impedance Network is a linear network of resistors and capacitors. The array of derivatives in the VarType structure that pass through the Complex Impedance Network will include the derivative variables for the adjustable parameters or components in the Complex Impedance Network itself. To assist in the processing of the VarType structure through the Complex Impedance Network a new structure was invented. This new structure is a ParTermType. The equation governing the rate of change of the output of the Non-Lead-Type Network 20 shown in FIG. 5b is:

$$\frac{ⅆ {e}_{o}}{ⅆ t} = \frac{1}{{R}_{1} {C}_{2}} [ {e}_{i n} - 5 {e}_{o} ] \qquad ( 7 )$$

When Equation (7) is used, the terms

$$\frac{ⅆ {e}_{o}}{ⅆ t} ,$$

eᵢₙ and e₀ are VarType structures. The term

$$\frac{1}{{R}_{1} {C}_{2}}$$

is a ParTerm1 Type structure. The ParTerm1Type structure will contain: 1) a float Value, for the value of the term; 2) a integer, PNum, for defining the derivative variables for the adjustable component or parameter in the VarType structure that will be modified; and 3) a derivative value called DValue, for expressing the derivative of the term with the adjustable component. As an example in Equation (7) the PNum will indicate the location in the VarType structure of the derivative variable for the adjustable component C₂, while the value DValue will be

$$- \frac{1}{{{R}_{1} ( {C}_{2} )}^{2}} .$$

The equation governing the rate of change of the output of a Lead-Type Network 501 shown in FIG. 5a is:

$$\frac{ⅆ {e}_{o}}{ⅆ t} = \frac{{C}_{1}}{{C}_{1} + {C}_{2}} \frac{ⅆ {e}_{i n}}{ⅆ t} + \frac{1}{{R}_{1} ( {C}_{1} + {C}_{2} )} [ {e}_{i n} - 5 {e}_{o} ] \qquad ( 8 )$$

In Equation (8) there are two terms with each term being a function of two adjustable components. The addition of the extra adjustable component to each term, requires a change in the definition of ParTermType. The ParTerm Type structure will contain: 1) a float Value, for the value of the term; 2) two integer, PNum[ ], for defining the location of the two derivative variables for the adjustable component or parameter in the term that must be modified; and 3) a derivative value called DValue[ ], for expressing the derivative of the term with the each of the two adjustable components. As an example the ParTermType for the expression

$$\frac{{C}_{1}}{{C}_{1} + {C}_{2}}$$

will be defined:

$$Value = \frac{{C}_{1}}{{C}_{1} + {C}_{2}}$$

PNum[0]=address for derivative variable for parameter C₁ in VarType structure.

PNum[1]=address for derivative variable for parameter C₂ in VarType structure.

$$DValue [ 0 ] = \frac{1}{{C}_{1} + {C}_{2}} - \frac{{C}_{1}}{{( {C}_{1} + {C}_{2} )}^{2}}$$

$$DValue [ 1 ] = - \frac{{C}_{1}}{{( {C}_{1} + {C}_{2} )}^{2}}$$

Because of the need to work with two types of ParTermType it is helpful to define two structures, ParTerm1Type and ParTerm2Type. The lag network only has one adjustable parameter. While it is possible to use the ParTerm2Type for the Non-Lead-Type Network or the Lag Network, the alternative to that approach was chosen.

When the VarType signal is passed through the Function Block of the node, or the multivariable power series, it is necessary to separate the structure into two parts. These parts are a float for the level and a structure called DVarType. This DVarType structure contains only the float pointer pDoutDa. The operators of addition to each other and multiplication by a float will be overloaded on this structure so the value of the DVarType output of a power series can be calculated easily. The equation used to calculate its value from a power series is:

$$\frac{ⅆ out}{ⅆ {a}_{j}} = \frac{ⅆ f}{ⅆ {a}_{j}} + {\sum }_{n = 1}^{N} ( \frac{ⅆ out}{ⅆ {y}_{n}} \frac{ⅆ {y}_{n}}{ⅆ {a}_{j}} ) \qquad ( 9 )$$

In the above equation the only float is

$$\frac{ⅆ out}{ⅆ {y}_{n}} ,$$

all other terms are actually structures of an array of derivative variables. The terms

$$\frac{ⅆ out}{ⅆ {a}_{j}} and \frac{ⅆ {y}_{n}}{ⅆ {a}_{j}}$$

are DVarType. The term

$$\frac{ⅆ f}{ⅆ {a}_{j}}$$

is not of type DVarType but it is still an array of derivative variables. It is of type DfDaType. The number of derivative variables in this structure depends on the number of parameters used in the multivariable power series it came from. The structure DfDaType also contains an integer describing where the array of parameters used in the power series start in the array of parameters or array of derivative variable in DVarType. The addition operation is overloaded on this structure to hide the complexity of all the additions represented in Equations (9) or (11). After the DVarType structure and the level output from the power series are obtained, they are recombined back into the structure VarType.

At each signal point in the system there are two VarType structures. One VarType structure contains the level signal while the other VarType structure contains the rate of change of the level signal. Although it is possible to use the VarType structure to define initial conditions, they are not relevant to this application and will not be discussed. The State Machine Block 101 is trained so that after the inputs have returned to their quiescent or zero level, all internal normal variables and output of all Recognition Nodes fairly quickly return to and remain at their quiescent level.

The sequence in which the nodes are processed is: 1) process all nodes passing a signal up the network, then 2) start at the top and process all nodes passing a signal down the network. The signals that must be passed through the multivariable power series are level and level time derivative. Both of these process signals are associated with an array of derivative variables. The value of the time derivative signals that out of the power series can be determined from:

$$\frac{ⅆ out}{ⅆ t} = {\sum }_{n = 1}^{N} ( \frac{ⅆ out}{ⅆ {y}_{n}} \frac{ⅆ {y}_{n}}{ⅆ t} ) \qquad ( 10 )$$

Associated with the level time derivative is a number of time derivatives for the level derivative variables. If vᵢⱼ is defined as the derivative

$$\frac{ⅆ {y}_{i}}{ⅆ {a}_{j}}$$

then:

$$\frac{ⅆ {v}_{ij}}{ⅆ t} = {\sum }_{n = 1}^{N} ( \frac{ⅆ out}{ⅆ {y}_{n}} \frac{ⅆ {v}_{nj}}{ⅆ t} ) \qquad ( 11 )$$

Since the form of Equations (10) and (11) are the same, there is no need to process the level and DVarType parts of the VarType separately. The VarType structure can be processed through the same equation. This means that the value of

$$\frac{ⅆ out}{ⅆ {y}_{n}}$$

is required to process the VarType structure for the time derivative and the D VarType structure for the level derivative variables. Effort should be made to make sure it is not calculated twice, but after it is calculated it should be stored for both uses.

After the two VarType structures are passed through the power series the inputs to Equation (8) are now available. The VarType structures that are the input to Equation (8) are eᵢₙ and

$$\frac{ⅆ {e}_{i n}}{ⅆ t} .$$

With these values and VarType structure for the output of the Lead-Type Network of e₀, the rate of change of the VarType output can be calculated. This VarType structure contains all the derivative variables, including the derivative variables for C₁ and C₂.

### Training

As previously explained with respect to FIG. 2, the training strategy for the State Machine Block 101 to recognize speech is simply to train the Recognition Node in the State Machine Block 101 to product a pulse a short period after the word data has been fed to the network. To quantify a discussion of the pulses it is necessary to define both trip levels and training levels. There is both an Upper Trip Level and a Lower Trip Level and an Upper Training Level and a Lower Training Level. A trip level is for determining how to qualify an output while a training level is for defining an error during training. Typically the relative values of the training and trip levels are:

Upper Training Level=1.0

Upper Trip Level =0.8

Lower Trip Level =0.4

Lower Training Level =0.2

Typically the quiescent or no input level of a Recognition Node 's output is zero, 0.0. This is not critical, and no effort needs to be made to train this level.

### Training Procedure

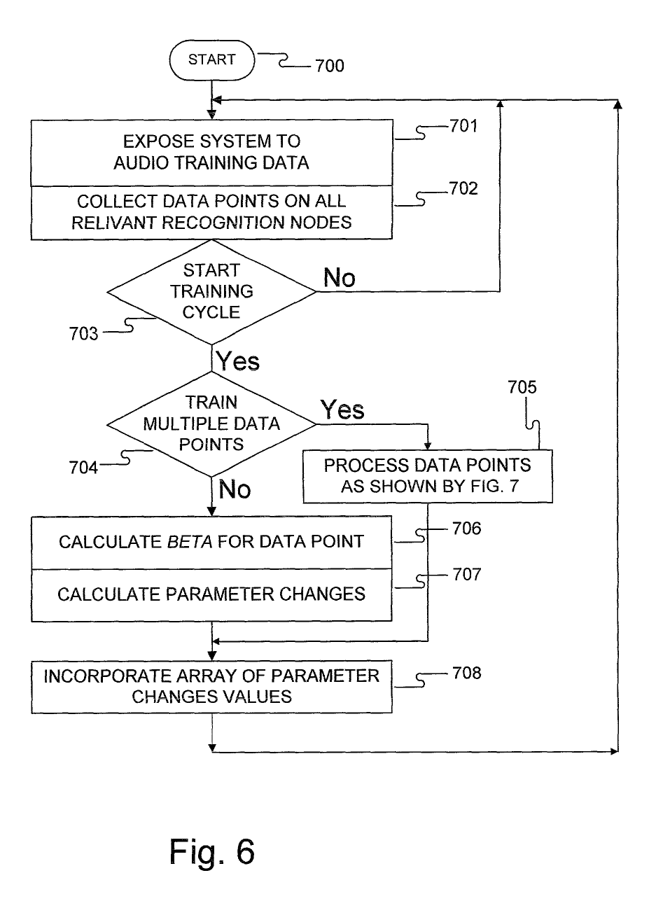

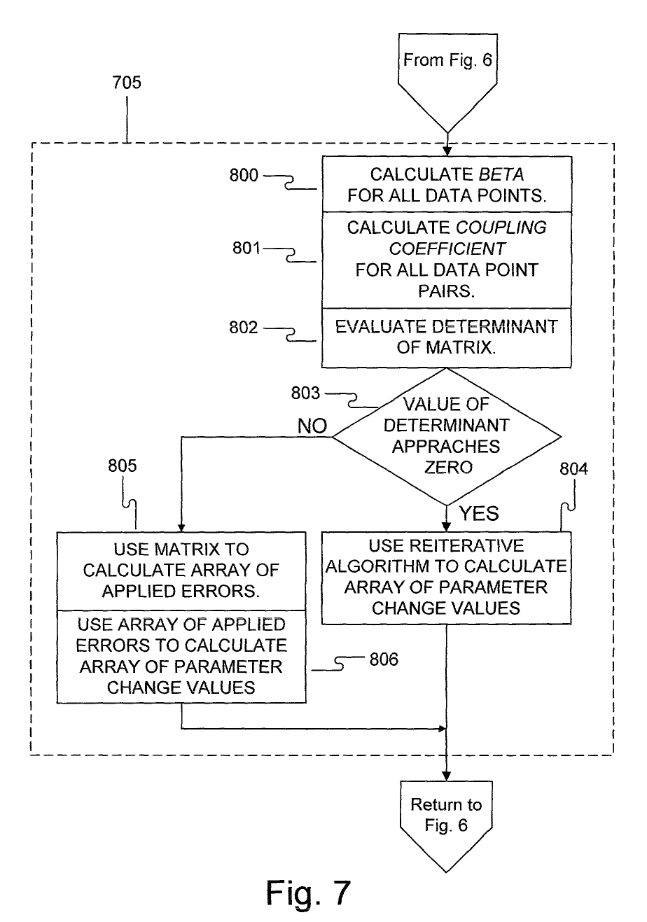

The training procedure used is outlined in connection with FIG. 6 and FIG. 7.

Referring to FIG. 6, in block 701, the Audio Word Detector 10 of FIG. 2 is exposed to the audio data of a word. At the proper time the training control line 205 signals Adjustment Block 105 to collect a data point from the appropriate Recognition Node. The data point information is collected in block 702. To permit a number of data points be collected in a number of training cycles, decision block 703 is used. If enough data points have not collected in a single data exposure, a number of data exposures may be performed. By exposing the Audio Word Detector 10 to both good and bad data for the same Recognition Node, multiple data points can be used in one training cycle. By doing so the Recognition Node can be trained to recognize distinctions. After a decision to start a training cycle has been made by decision block 703, decision block 704 must determine if multiple data points are being used. If multiple data points are being used, decision block 704 directs the process to block 705. If only a single data point is being used, the process is directed to block 706 where the beta value for the data point is calculated. The beta value is calculated using the value of all the derivative variables and is used with the error value to calculate an array of parameter change values in block 707. In block 708 the array of parameter change values is used to change the value of the parameters.

When multiple data points are being used in one training cycle, block 705 is used, as explained in connection with FIG. 7. In blocks 800 and 801 the beta values for all data points are calculated and the coefficients of a matrix are calculated. In block 802 the value of the determinant of the matrix created in block 801 is evaluated. The value of this determinant is used in Decision Block 803 to determine which procedure will be used to calculate an array of parameter change values, namely that of block 804 or of block 805. The reiterative algorithm used in block 804 will work on all cases. The test performed in block 803 is to shield the matrix algorithm used in block 805 and 806 from matrixes whose determinant's value approach zero. (The presentation of the matrix algorithm is mostly due to historical reasons and to present an alternative to the reiterative algorithm.) The procedures and algorithms discussed in the previous section are expanded in the following discussion.

### Training Algorithm

The training algorithm used depends on whether the objective is to train merely one Recognition Node or to train a plurality of Recognition Nodes. If the objective is to train only one Recognition Node, the training algorithm used may be the single data point algorithm. If the objective is to cause the Recognition Node to produce a Recognition Pulse, a data point is chosen at the point where the Recognition Pulse is expected to occur. At this data point defined by both Recognition Node to be trained and processing cycle that the Recognition Pulse should reach its peak value, all the derivative variables controlling this output are collected. The value of these derivative variables along with the value of the error is used to train this single data point. The value of the error is defined as the difference between desired level and the actual level. If the objective is to reduce the amplitude of a Recognition Pulse that should not have occurred, then at the point of maximum amplitude of the pulse, a data point is collected. Using the same single data point training algorithm, the amplitude of this false Recognition Pulse is reduced in amplitude below the Lower Trip Level by training its amplitude to be equal to the Lower Training Level. If the objective is to increase the amplitude of a Recognition Pulse to be greater than the value of the Upper Trip Level, the training or desired level will be the Upper Training Level.

### Single Data Point Training

The follow discussion explains the procedure used in blocks 706 and 707 of FIG. 6.

The training algorithm use to train a single data point is the same algorithm used to train a power series. As a review of this procedure, the change value of the parameters are calculated using the following equation:

$$Δ {a}_{j} = \frac{error}{Beta} ( \frac{ⅆ out}{ⅆ {a}_{j}} ) \qquad ( 12 )$$

where:

error=Training Level−Actual Level

$$Beta = {\sum }_{k = 0}^{J} {( \frac{ⅆ out}{ⅆ {a}_{k}} )}^{2}$$

The value of the parameters are then changed using:

αⱼ|_{new}=αⱼ|_{old}+Δαⱼ

Multiple Data Point Training

The training procedures explained in the following section are expansions of the procedures used in FIG. 7.

Training using multiple data points can involve the use of a matrix or the reiterative algorithm. The matrix attempts to compensate for the interacting of the change of parameters due to the training at one data point from affecting the output of the system at another data point. However before the matrix technique is used, the determinant of the matrix is evaluated. If the value of the determinant approaches zero, the data points are not considered linearly separable, and another technique must be used. This alternate training algorithm is referred to as the reiterative algorithm.

1) Matrix Training

The procedure explained in this section is expansion of the procedure used in blocks 805 and 806 of FIG. 7.

The matrix training method is dependent on calculation of a coupling constant between data points. The matrix that is constructed expresses error-actual as a linear combination of error-applied and coupling constants. The coupling from data s to data point t is:

$${G}_{s t} = \frac{{\sum }_{j = 0}^{J} ( [ \frac{ⅆ {y}_{o}}{ⅆ {a}_{j}} {\vert}_{t} ] [ \frac{ⅆ {y}_{p}}{ⅆ {a}_{j}} {\vert}_{s} ] )}{{\sum }_{j = 0}^{J} {( \frac{ⅆ {y}_{o}}{ⅆ {a}_{j}} {\vert}_{t} )}^{2}} \qquad ( 13 )$$

In Equation (13), o and p are functions of the outputs used for collection of data for data points t and s and as a result are a function of t and s respectively.

To illustrate this technique, it will be used to train two data points. The error-applied values (ERR₁ and ERR₂) that should be applied to exactly eliminate the error-actual values (error|₁ and error|₂) at the two data points can be determined from the solution of the following matrix:

$$[ \begin{matrix}1 & {G}_{12} \\ {G}_{21} & 1\end{matrix} ] [ \begin{matrix}{ERR}_{1} \\ {ERR}_{2}\end{matrix} ] = [ \begin{matrix}error {\vert}_{1} \\ error {\vert}_{2}\end{matrix} ] \qquad ( 14 )$$

1 G2 ERRI error 1 G_{21 1} ERRI2 error12

The above equation can be generalized for an arbitrary number N of data points as follows:

$$[ \begin{matrix}1 & {G}_{12} & ⋯ & {G}_{1 N} \\ {G}_{21} & 1 & ⋯ & {G}_{2 N} \\ ⋮ & ⋮ & ⋰ & ⋮ \\ {G}_{N1} & {G}_{N2} & ⋯ & 1\end{matrix} ] [ \begin{matrix}{ERR}_{1} \\ {ERR}_{2} \\ ⋮ \\ {ERR}_{N}\end{matrix} ] = [ \begin{matrix}error {\vert}_{1} \\ error {\vert}_{2} \\ ⋮ \\ error {\vert}_{N}\end{matrix} ] . \qquad ( 15 )$$

1 Gl]2 . . . GIN ERR, error G21 I . . . G2N ER i2 =error l. (15) GNI GN2 . I LERRN ro IN

This is a linear equation wherein the error-actual values on the right are the sum of products of the coupling coefficients and the error-applied values on the left.

A person skilled in the art would know that an array of ERR values can be selected to satisfy Equation (12) using standard linear algebra techniques such as Gaussian elimination. After the array of error-applied values (ERR) has been calculated, their values are used in the following equation to calculate the change in parameters.

$$\begin{matrix}Δ {a}_{j} = {\sum }_{n = 1}^{N} ( [ \frac{ⅆ {y}_{o}}{ⅆ {a}_{j}} {\vert}_{n} ] [ \frac{E R {R}_{n}}{B e t {a}_{n}} ] ) , & ( 16 ) \\ where B e t {a}_{n} = {\sum }_{j = 0}^{J} {( \frac{ⅆ {y}_{o}}{ⅆ {a}_{j}} {\vert}_{n} )}^{2} . & ( 17 )\end{matrix}$$

Remember that before using the above matrix technique, it is necessary to evaluate the determinant of the matrix. To see samples of code useful for implementing this algorithm reference is made to co-pending U.S. patent application Ser. No. 09/693,003 entitled “Method and Apparatus for Training a State Machine” in the name of the present inventor.

2) Evaluating a Determinant

The follow procedure is the procedure used in block 802 of FIG. 7 to determine the value used in Decision Block 803.

If a determinant is defined by:

$$D = \begin{matrix}{a}_{00} & {a}_{01} & ⋯ & {a}_{0 n} \\ {a}_{10} & {a}_{11} & ⋯ & {a}_{1 n} \\ ⋮ & ⋮ & ⋰ & ⋮ \\ {a}_{n0} & {a}_{n1} & ⋯ & {a}_{nn}\end{matrix} \qquad ( 18 )$$

D ₁₀ all all (18) an0 a ann

The value of the determinant can be determined from:

$$value = {\sum }_{j = 0}^{n} {( - 1 )}^{j} {a}_{0 j} {C}_{0 j} \qquad ( 19 )$$

where C₀ⱼ is the cofactor of term α₀ⱼ . In Equation (19), the value of the determinant is determined by expanding the determinant by the first row. The index of the coordinates of the terms in Equation (18) have been changed to correspond to the index used in a computer programing in C.

The cofactor of a term is defined as the value of a determinant defined by the original determinant after the row and column of the term have been removed. Each of the cofactors used in Equation (19) can in turn be evaluated used the same procedure used in Equation (19). Each time this reiterative procedure is used, the size of the determinant that must be delt with is reduced by one. This technique can continue until the size of the determinant is only a single term. When this occurs the value of the cofactor is simply the value of the remaining term.

The technique that has been choosen for passing the determinant of coefficients to the procedure is a float pointer. The size of this array of floats will be the product of the number of row by the number of collumns. For the matrix shown in Equation (18) this number will be (n+1)². The order in which these terms appear in the array is arbitrary but order that was choosen was to list all items in the first row, then all the items in the second row, etc. And then within each row the terms are list in increasing column number order.

3) Reiterative Technique

The procedure discussed in this section is the procedure used in block 804 of FIG. 7.

In this application, the reiterative technique will only be used it the value of the determinant of the matrix technique approaches zero. The objective of the reiterative technique is to adjust the parameters in a change value so that the predicted change in the state machine's output is equal to the error. The parameters that will be adjusted in the change value will be the array of parameter change values. At each data point, the change value will be subtracted from the error to produce a value called the training error. Since the objective is to make the change value to approximate the error, the objective can be also be stated as an attempt to minimize the sum of square of the training error at all data points. The procedure will then be to reiterate over all data points making minor change to the parameters in the change value to reduce the training error.

The change value is in general a linear combination of the derivative variables; however, if both the first and second order derivative variables used to calculate the value of the change value, the results would be:

$$change = {\sum }_{j = 0}^{J} ( \frac{ⅆ {y}_{i}}{ⅆ {a}_{j}} ) Δ {a}_{j} + {\sum }_{j , k = 0}^{J , K} ( \frac{{ⅆ}^{2} {y}_{i}}{ⅆ {a}_{j} ⅆ {a}_{k}} ) Δ {a}_{j} Δ {a}_{k} + \frac{1}{2} {\sum }_{j = 0}^{J} ( \frac{{ⅆ}^{2} {y}_{i}}{{ⅆ}^{2} {a}_{j}} ) {( Δ {a}_{j} )}^{2} \qquad ( 20 )$$

At each data point, the values of the parameter change values will be updated by:

where:

$$\begin{matrix}Δ {a}_{j} {\vert}_{new} = Δ {a}_{j} {\vert}_{old} + K \frac{Train Error}{Beta} ( \frac{ⅆ ( change )}{ⅆ ( Δ {a}_{j} )} ) & ( 21 ) \\ Beta = {\sum }_{j = 0}^{J} {( \frac{ⅆ ( change )}{ⅆ ( Δ {a}_{j} )} )}^{2} & ( 22 )\end{matrix}$$

The value of K is chosen as a compromise between a good rate of convergence and a value that will permit value of Δαⱼ to approach a stable value when all data points can not be learned exactly and some training error remains. The value of K is typically less than but very close to 1.

There are additional techniques that can be used for increasing the rate of convergence such as change data points and change of change data points. Because it is not know if these techniques are very useful in this application reference is made to U.S. patent application Ser. No. 09/693,003 filed Oct. 20, 2000 entitled “Method and Apparatus for Training a State Machine.”

### Use of Differential Variables

The use of differential variables is restricted to systems in which the only source of non-linearity is the multiplication of normal variables. Since the system being discussed uses multivariable power series as the only source of non-linearity, it satisfies the restriction. The use of differential variables for training have been thoroughly discussed in co-pending patent application Ser. No. 09/708,902, entitled “Structure of a Trainable State Machine,” filed Nov. 7, 2000 in the name of the present inventor. However, their use will be reviewed herein. It should be understood that it is not necessary to use differential variables for training if for example level variables are employed.

The technique used to transmit the differential signal through the non-linearity of a multiplication is to replace each variable with the sum of two variables. If:

out=xy

then:

out+Δout=(x+Δx)(y+Δy)

and as a result:

Δout=xΔy+yΔx+ΔxΔy (23)

The multiplication operation of a parameter time a variable is linear and can be summarized by the following equation. If:

out=αx

then:

Δout=αΔx (24)

The operations defined by Equations (23) and (24) allow the change output of a multivariable power series to be defined. If:

$$out = f ( \overline{y} )$$

then Δout can be expressed as:

$$Δ o u t = f ( \overline{y} , \overline{Δ y} )$$

The above information will be used to develop the state equations for processing the differential signal or differential variables through the network.

The state equations used for processing the level signal through the network can be expressed as:

$$\begin{matrix}\frac{ⅆ {y}_{i}}{ⅆ t} = {f}_{i} ( \overline{y} ) & ( 25 ) \\ {y}_{r} = \frac{ⅆ {y}_{n}}{ⅆ t} & ( 26 ) \\ {y}_{s} = {f}_{s} ( \overline{y} ) & ( 27 )\end{matrix}$$

Equations (26) and (27) include zeroes in the definition of the state machine.

In Equation (25), by replacing y with y+Δy the result is:

$$\frac{ⅆ ( {y}_{i} + Δ {y}_{i} )}{ⅆ t} = {f}_{i} ( \overline{y + Δ y} ) \qquad ( 28 )$$

Equation (28) can be rearranged to be:

$$\frac{ⅆ {y}_{i}}{ⅆ t} + \frac{ⅆ ( Δ {y}_{i} )}{ⅆ t} = {f}_{i} ( \overline{y} ) + Δ {f}_{i} ( \overline{y} , \overline{Δ y} ) \qquad ( 29 )$$

By using the results of Equation (25) to subtract an equivalent term from both sides of Equation (28), the result is:

$$\frac{ⅆ ( Δ {y}_{i} )}{ⅆ t} = Δ {f}_{i} ( \overline{y} , \overline{Δ y} ) \qquad ( 30 )$$

By following a similar procedure with Equations (26) and (27), the result is:

$$\begin{matrix}Δ {y}_{r} = \frac{ⅆ ( Δ {y}_{n} )}{ⅆ t} & ( 31 ) \\ Δ {y}_{s} = Δ {f}_{s} ( \overline{y} , \overline{Δ y} ) & ( 32 )\end{matrix}$$

Equations (30), (31) and (32) constitute the state equations for processing the differential variables. The plan is to let the level or normal variables stabilize to constant values and let the differential variables representative the only signal passing through the network.

To train the network it is necessary to use the derivative variables for the differential variables. To determine the state equations for processing the differential derivative variables, the same technique will be used to determine the state equations for processing the level derivative variables. This technique is to take the derivative of the state equations for processing the differential variables with a representative parameter.

By taking the derivative of Equation (30) with respect to a particular parameter αⱼ, the result is:

$$\frac{ⅆ {w}_{ij}}{ⅆ t} = \frac{ⅆ ( Δ {f}_{i} )}{ⅆ {a}_{j}} + {\sum }_{n = 1}^{N} [ ( \frac{ⅆ ( Δ {f}_{i} )}{ⅆ {y}_{n}} ) {v}_{nj} + ( \frac{ⅆ ( Δ {f}_{i} )}{ⅆ ( Δ {y}_{n} )} ) {w}_{nj} ] \qquad ( 33 )$$

where:

$${v}_{nj} = \frac{ⅆ {y}_{n}}{ⅆ {a}_{j}} \qquad {w}_{nj} = \frac{ⅆ ( Δ {y}_{n} )}{ⅆ {a}_{j}}$$

Equation (33) can be expressed as:

$$\frac{ⅆ {w}_{ij}}{ⅆ t} = {F}_{ij} ( \overline{y} , \overline{Δ y} , \overline{v} , \overline{w} ) \qquad ( 34 )$$

Equation (34) is one of the state equations that can be used to processing the differential derivative variables. The procedure will be repeated to determine the remaining state equations for processing the differential derivative variables. The result of this process is:

$$\begin{matrix}{w}_{rj} = \frac{ⅆ {w}_{nj}}{ⅆ t} & ( 35 ) \\ {w}_{sj} = {F}_{sj} ( \overline{y} , \overline{Δ y} , \overline{v} , \overline{w} ) & ( 36 )\end{matrix}$$

Equations (34), (35) and (36) are a set of state equations for processing the differential derivative variables. Both the differential derivative variables and the error in the level of the differential variable, can be used to train the state machine.

In a previous section it was suggested that the normal variables be stabilized by setting the State Machine Block's inputs to zero. For the State Machine Block used in this application, this will cause the normal variables to stabilize to constant values. Since the normal variables stabilize to constant values, the normal derivative variables will also stabilize to constant values. This means that to train the State Machine Block using differential variables, it is only necessary to process two set of state equation—those for the differential variables and those for the differential derivative variables. To accomplish this it is suggested that input be set to zero and the state equations for the normal variables and normal derivative variables be processed until they reach stable values. These values are stored for use in the processing of the differential variables and differential derivative variables.

To process the differential variables through the non-linearity of the multivariable power series, two addition derivatives are required. These additional derivatives are:

$$\frac{ⅆ Δ f}{ⅆ Δ y} and \frac{ⅆ Δ f}{ⅆ y} .$$

A verbal description of these derivatives are: 1) derivative of differential variable output of the multivariable power series with one of the differential variable input to the power series; 2) derivative of the differential variable output of the multivariable power series with the value of the normal variable of one of the inputs to the power series.

Similarly, to calculate the differential derivative variable output of a multivariable power series the value of derivative

$$\frac{ⅆ Δ f}{ⅆ {a}_{j}}$$

is required. The techniques use to calculating the values of

$$\frac{ⅆ Δ f}{ⅆ Δ y} , \frac{ⅆ Δ f}{ⅆ y} , and \frac{ⅆ Δ f}{ⅆ {a}_{j}}$$

are rather involved and will not be discussed in this application. The technique and C++ code used for their calculation were thoroughly discussed in application Ser. No. 09/708,902 entitled “Structure of a Trainable State Machine,” filed Nov. 7, 2000 in the name of the present inventor.

The equations required for passing the differential variables and differential derivative variables through the multivariable power series will also be reviewed. As a review the equation used to calculate the normal derivative variable output of a multivariable power series is:

$$\frac{ⅆ ( \frac{ⅆ {y}_{i}}{ⅆ {a}_{j}} )}{ⅆ t} = \frac{ⅆ {f}_{i}}{ⅆ {a}_{j}} + {\sum }_{n = 1}^{N} ( \frac{ⅆ {f}_{i}}{ⅆ {y}_{n}} ) ( \frac{ⅆ {y}_{n}}{ⅆ {a}_{j}} )$$

which can also be written as:

$$\frac{ⅆ {v}_{ij}}{ⅆ t} = \frac{ⅆ {f}_{i}}{ⅆ {a}_{j}} + {\sum }_{n = 1}^{N} ( \frac{ⅆ {f}_{i}}{ⅆ {y}_{n}} ) {v}_{nj} \qquad ( 37 )$$

where vᵢⱼ is derivative variable for normal variable yᵢ, and parameter, αⱼ.

To calculate the value of the differential variable output of a multivariable power series, the required equation is:

$$\frac{ⅆ Δ {y}_{i}}{ⅆ t} = {\sum }_{n = 1}^{N} ( \frac{ⅆ Δ {f}_{i}}{ⅆ Δ {y}_{n}} ) ( \frac{ⅆ Δ {y}_{n}}{ⅆ t} ) + {\sum }_{n = 1}^{N} ( \frac{ⅆ Δ {f}_{i}}{ⅆ {y}_{n}} ) ( \frac{ⅆ {y}_{n}}{ⅆ t} ) \qquad ( 38 )$$

Normally when the differential variables are processed through the State Machine Block, the normal variables have stabilized to constant values. When this occurs the second term of Equation (38) is zero and Equation (38) can be simplified to:

$$\frac{ⅆ Δ {y}_{i}}{ⅆ t} = {\sum }_{n = 1}^{N} ( \frac{ⅆ Δ {f}_{i}}{ⅆ Δ {y}_{n}} ) ( \frac{ⅆ Δ {y}_{n}}{ⅆ t} ) \qquad ( 39 )$$

To calculate the differential derivative variable output of a multivariable power series, the following equation is used:

$$\frac{ⅆ Δ {y}_{i}}{ⅆ {a}_{j}} = \frac{ⅆ Δ {f}_{i}}{ⅆ {a}_{j}} + {\sum }_{n = 1}^{N} ( \frac{ⅆ Δ {f}_{i}}{ⅆ Δ {y}_{n}} ) ( \frac{ⅆ Δ {y}_{n}}{ⅆ {a}_{j}} ) + {\sum }_{n = 1}^{N} ( \frac{ⅆ Δ {f}_{i}}{ⅆ {y}_{n}} ) ( \frac{ⅆ {y}_{n}}{ⅆ {a}_{j}} ) \qquad ( 40 )$$

Equation (40) is normally written as:

$${w}_{ij} = \frac{ⅆ Δ {f}_{i}}{ⅆ {a}_{j}} + {\sum }_{n = 1}^{N} ( \frac{ⅆ Δ {f}_{i}}{ⅆ Δ {y}_{n}} ) {w}_{nj} + {\sum }_{n = 1}^{N} ( \frac{ⅆ Δ {f}_{i}}{ⅆ {y}_{n}} ) {v}_{nj} \qquad ( 41 )$$

In Equation (41) the variable wᵢⱼ is the differential derivative variable for differential variable, Δyᵢ, and parameter αⱼ.

Need and Techniques for Adjusting Values of Derivative Variables

The technique used to calculate the change of a parameter from a data point causes the change in value of a parameter to be proportional to the value of this parameter's derivative variable. Even when using the reiterative algorithm with a change variable the determination of which parameter receives most of the adjustment is distorted by the relative value of the derivative variables. There are two techniques that can be used to distort this normal distribution to a distribution that will be more effective in learning the task. One technique is to change the relative values of the derivative variables as they are generated. The second technique is to change the relative values of the derivative variables as sort of a preprocessing step before the derivative variables are used by the training algorithm. Both techniques involve classifying the derivative variables according to type of parameter used in their generation or type of parameter they are used to control. The ideal solution is for the average values of all the derivative variable types be to equal.

To implement the first technique, the code for the following operations must be modified: 1) the addition of the DfDaType structure to the DVarType or a VarType structures; 2) the multiplication of a ParTermType structure by a VarType structure; 3) the addition of a parameter change value to a parameter value.

As an example of this procedure, if the signal output of a branch is governed by:

e₀=αⱼeᵢₙ

Then the derivative variable for parameter αⱼ output of this branch using the derivative variable value modification technique will be:

$$\frac{ⅆ {e}_{o}}{ⅆ {a}_{j}} = {a}_{j} ( \frac{ⅆ {e}_{i n}}{ⅆ {a}_{j}} ) + {M}_{j} {e}_{i n} \qquad ( 42 )$$

In Equation (42), the constant Mⱼ is the arbitrary constant used to modify the value of derivative variable for parameter αⱼ. The value of the constant Mⱼ will be the same as the constant used to modify the value of all derivative variables from parameters of this type.

When the array of parameter change values are incorporated to modify the parameter values, the following equation is used:

αⱼ+=MⱼΔαⱼ (43)

In Equation (43), the constant Mⱼ is the same constant used in Equation (42) for derivative variable generation.

The second technique to modify the normal distribution so the training algorithm will be more effective is to change the relative value of the derivative variables not as they are generated, but just before they are used. The second technique is then to preprocess the data points just before they are used by the training algorithm. After the data point information has been collected and just before the data point information is used by the training algorithm to calculate an array of parameter change values, the average value of the derivative variables for each parameter type is calculated. This array of average values are used to calculate the value of Mⱼ. This array of Mⱼ values are used to modify the values of the derivative variables in the data points and in Equation (43) when the array of parameter change values are used.

In each of these techniques the value of Mⱼ is dependent on the type of parameter or derivative variable involved. In the DfDaType structure the parameter can be classified according to order of the polynomial with each variable. For a second order polynomial with two variables, can be referred as 00, 01, 02, 10, 11, 12, 20, 21, and 22. In these numbers the first digit refers to the order of the polynomial with one variables while the second digit refers to the order of the polynomial with the second variable. These parameters may be grouped as: 1) 00. 2) 01, and 10. 3) 02, and 20. 4) 12, and 21. 5) 22. Each of these parameter groups could have their own unique Mi. The Complex Impedance Network shown in FIG. 5a contains two adjustable parameters. These parameters are C, and C₂. Cl could be classified as a LEAD component while C₂ could be classified as a LAG component. Since this discussion has been presented in another patent application of the same inventor, the discussion here has been brief. For a complete discussion, see the patent application “Structure of a Trainable State Machine,” Ser. No. 09/708,902 filed Nov. 7, 2000, and incorporated herein by reference.

### PRACTICAL APPLICATIONS

The objective of the application is to disclose a design of system capable of understanding speech. The same system is capable of being trained to recognize the return reflection of a multi-channel radar system or recognizing the propeller notice of a ship or submarine. Another advantage of the system is its self-learning ability. To train the system it is only necessary to expose it to the signal and tell it what the signal is. Throughout the discussion very little said about the sampling rate or the frequencies in the input signal. The only requirement for the system to be able to recognize it is that input signal vary as a function of time.

The invention has been explained with reference to specific embodiments. Other embodiments will be evident to those of ordinary skill in the art. It is therefore not intended that this invention be limited, except as indicated by the appended claims.

What is claimed is:

1. In a system having amplitude varying input signals, a method for recognition of objects contained within an amplitude varying input signals, said method comprising:
applying said amplitude varying input signals to a state machine, said state machine having recognition nodes, each of said recognition nodes used for recognition of only one of said objects;
scanning output of said recognition nodes with an output scanner; and
categorizing said output of said recognition nodes as indication of recognition of said objects.

2. The method of claim 1 wherein said categorizing stepproduces as indication of recognition a pulse whose amplitude is greater than a fixed limit.

3. The method of claim 1 in which said input signal is multi-channel.

4. The method of claim 1 further including a prior step of applying said amplitude varying input signals to a frequency discriminator to produce said representations of said amplitude varying input signals.

5. The method of claim 1 further including the step of:
training recognition nodes of said state machine using error in level of said recognition signal with reference to a desired response of said recognition signal.

6. The method of claim 5 wherein the training of each said recognition node uses derivative variables, said derivative variables representing derivatives of output of said recognition node with parameters in said state machine, and wherein said parameters control behavior of said state machine.

7. The method of claim 1 wherein a desired response of all recognition nodes is a pulse having an amplitude less than a lower trip level or greater than a higher trip level.

8. The method of claim 5 wherein a desired response of all recognition nodes for calculation of error is a pulse having an amplitude less than a lower training level or greater than a higher training level and wherein said lower training level is lower than a lower trip level and said higher training level is higher than a higher trip level.

9. The method of claim 1 wherein each of said state equations is defined as a node containing a multivariable power series and a Complex Impedance Network, wherein inputs to said node are inputs to said multivariable power series and output of said multivariable power series is input to said Complex Impedance Network and a single output of said Complex Impedance Network is output of said node.

10. The method of claim 9 wherein said Complex Impedance Network is either a Lead-Type Network or a Non-Lead-Type Network, and wherein rate of change of output of said Lead-Type Network is a function of at least rate of change of input of said Lead-Type Network and wherein the rate of change of output of said Non-Lead-Type Network is a function of only level of input to said Non-Lead-Type Network.

11. The method of claim 10 wherein the nodes containing a Lead-Type Network are referred to as Lead-Type Nodes and nodes containing a Non-Lead-Type Network are referred to as Non-Lead-Type Nodes, and said state machine has a top and a bottom, and wherein input to said state machine is supplied to the top and outputs (Recognition Nodes) are at the bottom and the nodes passing signals in the direction of from the bottom to the top are restricted to Non-Lead-Type Nodes.

12. The method of claim 1 in which the signals transmitted through said state machine are differential variables, said differential variables being a change of the normal variables from their normal level, said method comprising:
(a) defining inputs to said state machine as the sum of a normal variable, y, and a differential variable, Δy;
(b) defining a new function Δƒ(\overline{y}, \overline{Δy}), where said new function is defined so ƒ(\overline{y+Δy}) can be expressed as the sum of ƒ(\overline{y}) and said new function, said new function existing only if the only source of non-linearity in the function ƒ(\overline{y}) in said original set of state equations is the multiplication of normal variables;
(c) defining a second set of state equations from said original set of state equations and said new function, said second set of state equations for processing a second set of state variables referred to as differential variables, said second set of state equations only existing if the only source of non-linearity in the functions used in said original set of state equations is multiplication; then
(d) processing said differential variables throughout said state machine using said second set of state equations; thereafter
(e) observing values of said differential variables at the recognition nodes of said state machine; and
(f) using said differential variables of said recognition nodes as indication of recognition of said objects.

13. The method of claim 12 further including training said state machine, said training method comprising:
(a) taking derivative of each of said original set of state equations with respect to each adjustable parameter in said state machine to produce a second set of state equations used for processing a second set of state variables called derivative variables;
(b) by defining a new variable referred to as differential variables as the being summed with the normal variable at the system inputs to said state machine, and if the only source of non-linearity in said state machine is the results of multiplication of normal variables, a third set of state equations can be generated for processing a third set state variables referred to as said differential variables;
(c) taking the derivative of each of said third set of state equations with respect to each adjustable parameter in said state machine to produce a fourth set of state equations used to process a fourth set of state variables called derivative variables for differential variables or differential derivative variables;
(d) defining an output differential variable as one of said differential variables;
(e) defining an error variable as the difference between the desired level of said output differential variable and its actual level; and
(f) using said error variable with the level of differential derivative variables associated with said output differential variable to adjust each said adjustable parameter to control behavior of said output differential variable.

14. The method of claim 13 further including:
training said state machine to have normal variables that stabilize to constant values when said system inputs are held at constant values for some period; then
storing, at all signal points in said state machine, constant values of both normal variables and derivative variables, such that the constant values of normal variables and derivative variables can be used to process the differential variables and the differential derivative variables as the only two dynamic signals in said state machine when said state machine is trained using differential variables.

15. The method of claim 4 further including:
adjusting the relative value of the derivative variables used for training to increase the training rate, said adjusting comprising:
multiplying value used at point of derivative variable generation by an adjustment value, then
calculating an array of parameter change values, and then
multiplying a corresponding parameter adjustment value by said adjustment value before adding to a corresponding parameter and befor incorporating said array of parameter adjustment values into parameters controlling behavior of said state machine.

16. The method of claim 4 further including:
adjusting the relative value of the derivative variables used for training to increase the training rate, said adjusting comprising:
multiplying value of derivative variables in data points after the data point values have been collected by an adjustment value, then
calculating an array of parameter change values, and then
multiplying a corresponding parameter adjustment value by said adjustment value before adding to a corresponding parameter and befor incorporating said array of parameter adjustment values into parameters controlling behavior of said state machine.

17. The method of claim 13 further including:
adjusting the relative value of the derivative variables used for training to increase the training rate, said adjusting comprising:
multiplying value used at point of derivative variable generation by an adjustment value, then
calculating an array of parameter change values, and then
multiplying a corresponding parameter adjustment value by said adjustment value before adding to a corresponding parameter and befor incorporating said array of parameter adjustment values into parameters controlling behavior of said state machine.

18. The method of claim 13 further including:
adjusting the relative value of the derivative variables used for training to increase the training rate, said adjusting comprising:
multiplying value of derivative variables in a data point after the data point has been collected by an adjustment value, then
calculating an array of parameter change values, and then
multiplying a corresponding parameter adjustment value by said adjustment value before adding to a corresponding parameter and befor incorporating said array of parameter adjustment values into parameters controlling behavior of said state machine.
